(19) United States
(12) Patent Application Publication
(10) Pub. No.: US 2015/0145749 A1
(43) Pub. Date: May 28, 2015

(54) IMAGE PROCESSING APPARATUS AND IMAGE PROCESSING METHOD

(71) Applicant: SONY CORPORATION, Tokyo (JP)

(72) Inventors: SHINJI INAMOTO, TOKYO (JP); YASUYUKI HIRAO, TOKYO (JP); MAKOTO WAKAMATSU, TOKYO (JP)

(21) Appl. No.: 14/526,804

(22) Filed: Oct. 29, 2014

(30) Foreign Application Priority Data
Nov. 26, 2013 (JP) 2013-244087

(51) Int. Cl. G06F 3/14

(52) U.S. Cl. CPC G06F 3/1438; G06F 3/1446
USPC 345/1.3

(57) ABSTRACT

There is provided an image processing apparatus including a content analysis unit configured to analyze a display range of an object included in content displayed in a plurality of displays, and an image processing unit configured to generate drawing information for drawing the object and to transmit the drawing information to only an apparatus responsible for display processing in at least one of the displays that includes the display range acquired through the analysis by the content analysis unit.

### CROSS REFERENCE TO RELATED APPLICATIONS

This application claims the benefit of Japanese Priority Patent Application JP 2013-244087 filed Nov. 26, 2013, the entire contents of which are incorporated herein by reference.

### BACKGROUND

The present disclosure relates to an image processing apparatus and an image processing method.

Multi-display systems using tiled arrangement of a plurality of displays to implement display on a single large screen are widely used for digital signage systems, information display systems, and the like in commercial facilities, for example.

Technologies related to the multi-display systems are disclosed in, for example, JP H7-199881A and JP 2008-96748A. Each of JP H7-199881A and JP 2008-96748A discloses a multi-display system including a master node and slave nodes, the master node generating drawing resources and drawing commands, the slave nodes displaying an image based on the drawing resources and the drawing commands generated by the master node.

### SUMMARY

When the multi-display system displays an image, it is desired for the master node to reduce a drawing-resource generation load resulting from transmitting all the drawing resources to all the slave nodes. In contrast, it is desired for each slave node to reduce a processing load increased by receiving the drawing resources even not intended for display in the slave node itself.

In light of the foregoing, it is desirable to provide an image processing apparatus and an image processing method, which are novel and improved, and which can reduce loads on nodes when a multi-display system displays an image.

According to an embodiment of the present disclosure, there is provided an image processing apparatus including a content analysis unit configured to analyze a display range of an object included in content displayed in a plurality of displays, and an image processing unit configured to generate drawing information for drawing the object and to transmit the drawing information to only an apparatus responsible for display processing in at least one of the displays that includes the display range acquired through the analysis by the content analysis unit.

According to another embodiment of the present disclosure, there is provided an image processing apparatus including a communication processing unit configured to receive drawing information for drawing an object included in content displayed in a plurality of displays, the drawing information being transmitted to only an apparatus responsible for display processing in at least one of the displays that includes a display range of the object, and an image processing unit configured to display the object in the display responsible for displaying the object, based on the drawing information received by the communication processing unit.

According to another embodiment of the present disclosure, there is provided an image processing method including analyzing a display range of an object included in content displayed in a plurality of displays, and generating drawing information for drawing the object and transmitting the drawing information to only an apparatus responsible for display processing in at least one of the displays that includes the display range acquired by analyzing the display range of the object.

According to another embodiment of the present disclosure, there is provided an image processing method including receiving drawing information for drawing an object included in content displayed in a plurality of displays, the drawing information being transmitted to only an apparatus responsible for display processing in at least one of the displays that includes a display range of the object, and displaying the object in the display responsible for displaying the object, based on the received drawing information.

According to the embodiments of the present disclosure described above, it is possible to provide an image processing apparatus and an image processing method, which are novel and improved, and which can reduce load on nodes when a multi-display apparatus displays an image.

Note that the aforementioned advantageous effects are not necessarily limited, and any of advantageous effects described in the specification or other advantageous effects known from the specification may be exerted in addition to or instead of the advantageous effects described above.

### BRIEF DESCRIPTION OF THE DRAWINGS

FIG. 1 is an explanatory diagram illustrating a configuration example of a multi-display system 1 according to an embodiment of the present disclosure;

FIG. 2 is an explanatory diagram illustrating a configuration example of the multi-display system 1 according to an embodiment of the present disclosure;

FIG. 3 is an explanatory diagram for explaining where to transmit a drawing resource and a drawing command in displaying an image in the multi-display system;

FIG. 4 is an explanatory diagram illustrating functional configuration examples of a master node 100 and a slave node 200;

FIG. 5 is an explanatory diagram for explaining a method for transmitting a drawing resource;

FIG. 6 is an explanatory diagram for explaining the method for transmitting a drawing resource;

FIG. 7 is an explanatory diagram for explaining the method for transmitting a drawing resource;

FIG. 8 is a flow chart illustrating an operation example of the multi-display system 1;

FIG. 9 is a flow chart illustrating an operation example of the multi-display system 1;

FIG. 10 is an explanatory diagram illustrating a functional configuration example of the master node 100;

FIG. 11 is an explanatory diagram illustrating a functional configuration example of the master node 100; and

FIG. 12 is an explanatory diagram illustrating a hardware configuration example.

### DETAILED DESCRIPTION OF THE EMBODIMENT

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that description will be provided in the following order.

1. Embodiment of Present Disclosure

1.1. System Configuration Examples

1.2. Functional Configuration Examples

1.3. Operation Examples

1.4. Modifications

2. Hardware Configuration Example

3. Conclusion

### 1. EMBODIMENT OF PRESENT DISCLOSURE

### 1.1. System Configuration Examples

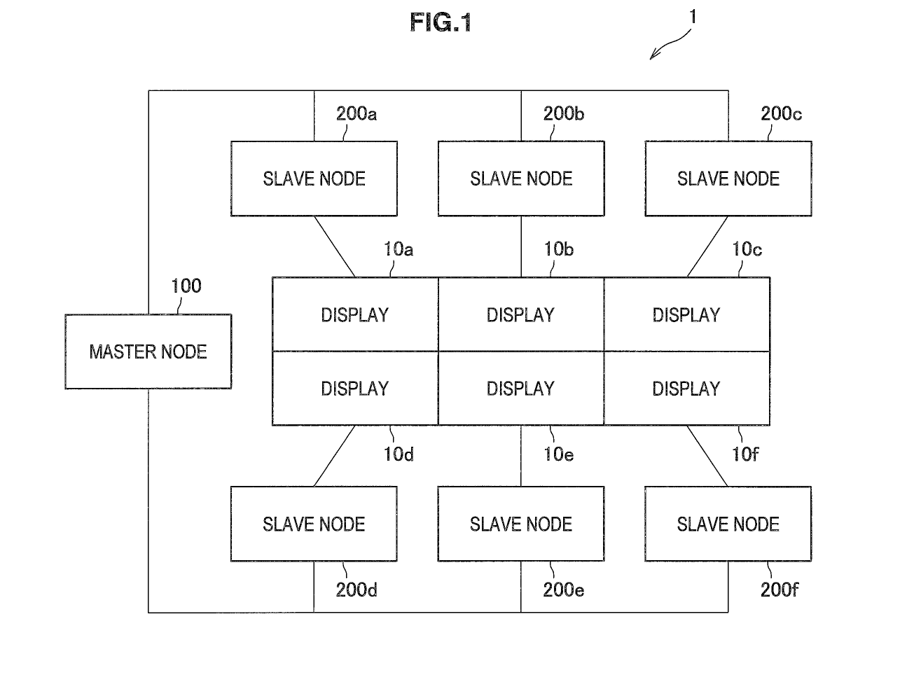

Firstly, configuration examples of a multi-display system according to an embodiment of the present disclosure will be described with reference to the drawings. FIG. 1 is an explanatory diagram illustrating a configuration example of a multi-display system 1 according to an embodiment of the present disclosure. Hereinafter, a configuration example of the multi-display system 1 according to an embodiment of the present disclosure will be described by using FIG. 1.

As illustrated in FIG. 1, the multi-display system 1 according to an embodiment of the present disclosure is a system configured to display one image in six displays 10a, 10b, 10c, 10d, 10e, and 10f that are arranged in tiles. As illustrated in FIG. 1, the multi-display system 1 according to an embodiment of the present disclosure includes a master node 100 and slave nodes 200a, 200b, 200c, 200d, 200e, and 200f. The master node 100 generates drawing resources and drawing commands for an image to be displayed in the displays 10a to 10f each taking responsibility for displaying a part of the image. The slave nodes 200a to 200f receive the drawing resources and drawing commands generated by the master node 100 and displays the image in the displays 10a to 10f based on the received drawing resources and drawing commands.

The master node 100 is connected to the slave nodes 200a to 200f by using, for example, network cables for wired communication or cables for video transmission. Likewise, the slave nodes 200a to 200f are connected to the displays 10a to 10f by using, for example, network cables for wired communication or cables for video transmission. Note that in the example in FIG. 1, the slave nodes 200a to 200f are connected to the displays 10a to 10f, respectively, but the embodiment of the present disclosure is not limited to the example. In other words, a single slave node may be connected to a plurality of display devices.

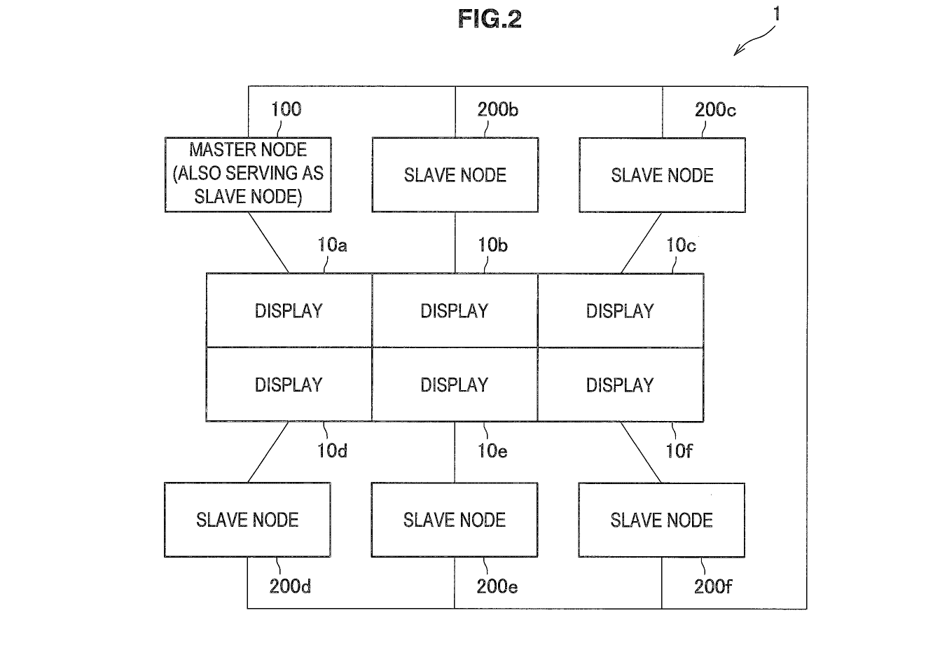

In addition, the example in FIG. 1 shows a configuration in which the master node 100 is completely separated from the slave nodes 200a to 200f, but the embodiment of the present disclosure is not limited to the example. For example, as illustrated in FIG. 2, the master node 100 may be configured to serve as one of the slave nodes.

In the multi-display system 1 according to an embodiment of the present disclosure, the master node 100 generates the drawing resources and drawing commands and transmits the generated drawing resources and drawing commands to the slave nodes 200a to 200f as described above. Here, in the multi-display system 1 according to an embodiment of the present disclosure, each drawing resource and each drawing command generated by the master node 100 are transmitted to only at least one of the slave nodes which is responsible for a partial image displayed by using the drawing resource and drawing command.

The description has heretofore been provided of the system configuration example of the multi-display system 1 according to an embodiment of the present disclosure. Subsequently, description is provided of an advantage exerted by transmitting the drawing resource and drawing command generated by the master node 100 to only the slave node responsible for the partial image displayed by using the drawing resource and drawing command.

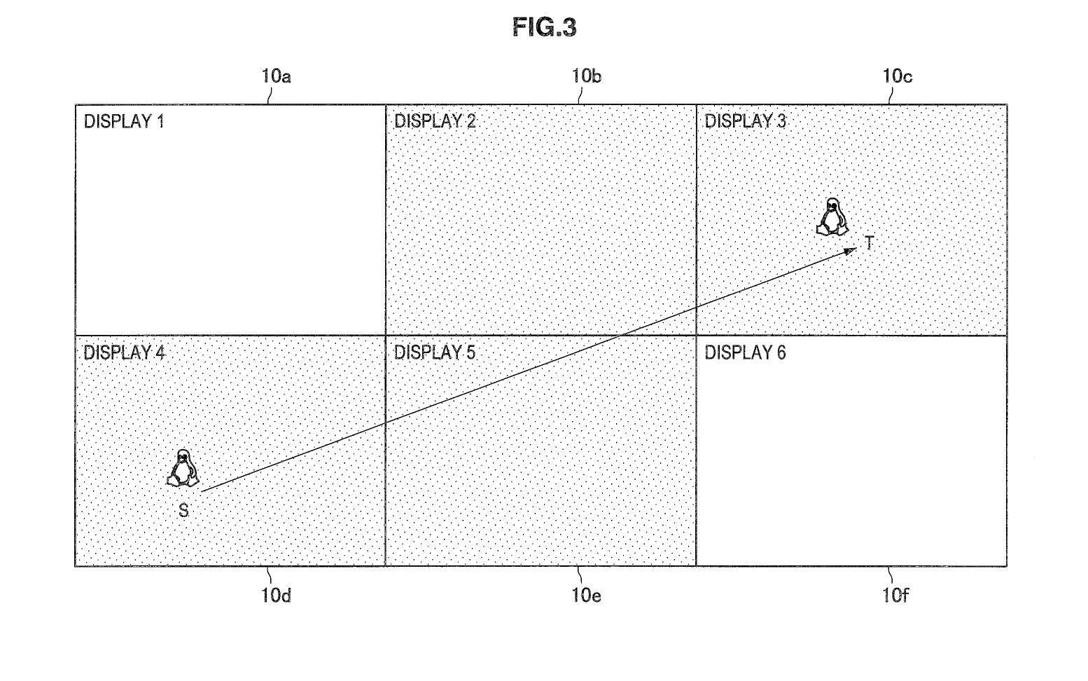

FIG. 3 is an explanatory diagram for explaining where to transmit a drawing resource and a drawing command in displaying an image in the multi-display system. By using FIG. 3, description is hereinafter provided of the advantage exerted by transmitting the drawing resource and the drawing command generated by the master node 100 to only the slave node responsible for the partial image displayed by using the drawing resource and drawing command.

The following describes as an example a case where a picture of a penguin in FIG. 3 moves linearly from a start point S of a display 4 to a terminal point T of a display 3. The description is provided on the assumption that a multi-display system in FIG. 3 has displays connected to respective slave nodes, like the multi-display system 1 in FIG. 1.

Description is firstly provided of a case (unicast transmission case) where the master node firstly designates only one of the slave nodes to which a drawing resource is transmitted. In the case of unicast transmission, to display the penguin in the display 4, the master node transmits a drawing resource (penguin picture) to the slave node responsible for displaying the display 4, only once for the first time.

To implement an animation in which the penguin picture moves, the master node thereafter transmits in order a drawing command for the drawing resource to the slave node responsible for displaying the display 4.

When the penguin thereafter moves and then lies astride the display 4 and a display 5, the master node transmits the drawing resource (penguin picture) to a slave node responsible for displaying the display 5 only once for the first time, as well as the slave node responsible for displaying the display 4. To implement the animation in which the penguin picture moves, the master node thereafter transmits in order the drawing command to the slave nodes responsible for displaying the displays 4 and 5. Note that the same slave node might be responsible for displaying the displays 4 and 5.

When the penguin thereafter further moves to be displayed in only the display 5, the master node stops transmitting the drawing command to the slave node responsible for displaying the display 4 and transmits the drawing command for displaying the penguin to only the slave node responsible for displaying the display 5. Subsequently, transmitting the drawing resource and drawing command from the master node to the corresponding slave node and stopping the transmitting are repeated until the penguin moves to the terminal point T.

In the case of unicast transmission as described above, when an object moves while moving astride the displays, it is necessary that the master node transmit the same drawing resource to each slave node in order as the object moves. This increases costs of transmitting a drawing resource for large-size data. Also, in the case of unicast transmission, each slave node starts receiving the drawing resource for large-size data when the object display becomes necessary. Accordingly, time before displaying becomes long, and consequently it might be difficult to implement a smooth animation.

Subsequently, description is provided of a case (broadcast transmission case) where a drawing resource generated by the master node is firstly transmitted to all the slave nodes. In the case of broadcast transmission, even though the penguin is to be displayed in the display 4, the master node transmits the drawing resource (penguin picture) to not only the slave node responsible for displaying the display 4 but also all the slave nodes only once for the first time. To implement the animation in which the penguin picture moves, the master node transmits in order the drawing command to the slave node responsible for displaying the display 4.

When the penguin thereafter moves and then lies astride the display 4 and the display 5, the slave node responsible for displaying the display 5 can display the penguin in the display 5 by receiving the drawing command in order from the master node without receiving the drawing resource for displaying the penguin picture from the master node. This is because the slave node responsible for displaying the display 5 has already received the drawing resource for displaying the penguin picture.

In the case of broadcast transmission as described above, the master node transmits the same drawing resource to all the slave nodes in advance and transmits in order the drawing command to the corresponding slave node responsible for displaying the object as the object moves. In the case of broadcast transmission, however, the drawing resource is transmitted to even the slave nodes responsible for displaying display in which the partial image using the drawing resource and drawing command is not displayed. The slave nodes on which displaying processing does not have to be performed incur costs of receiving the drawing resource.

In addition, regardless of whether the unicast transmission case or the broadcast transmission case, the master node might often not be able to generate the drawing command in advance. For example, in a case where a user operates a menu or the like by touching a touch panel provided on the display, the menu or the like is displayed in the display based on a drawing command in accordance with the user operation. However, it is not predictable when and which menu the user operates, and thus it is difficult for the master node to generate a drawing command in advance.

Hence, the multi-display system 1 according to an embodiment of the present disclosure uses a method for transmitting a drawing resource which is new and can reduce generation, transmission, and reception costs. The generation and transmission costs are incurred when the master node generates a drawing resource and transmits the drawing resource to a new slave node in the case of unicast transmission. The reception costs are incurred in receiving a drawing resource which does not have to be processed by the slave nodes in the case of the broadcast transmission.

When the penguin moves linearly as in FIG. 3, the master node can in advance know that the penguin image moves to four displays that are a display 2, a display 3, and the displays 4 and 5. Thus, the master node in advance transmits the drawing resource for displaying the penguin picture to the slave nodes responsible for displaying the respective displays 2, 3, 4, and 5. Then, the master node transmits in order the drawing command to the slave nodes responsible for displaying the penguin picture. If the penguin picture moves linearly from the start point S to the terminal point T, the master node and the slave nodes do not have to generate the drawing resource for any slave node responsible for display not intended for the penguin picture and do not have to transmit and receive the drawing resource. Thus, it is possible to reduce the costs incurred.

By using FIG. 3, the description has heretofore been provided of the advantage in which the drawing resource is transmitted to only the slave nodes responsible for displaying the image using the drawing resource and drawing command. Subsequently, description is provided of functional configuration examples of the master node 100 and the slave nodes 200a to 200f (hereinafter, simply referred to as the slave nodes 200 when discrimination is not necessary) of the multi-display system 1 according to an embodiment of the present disclosure.

### 1.2. Functional Configuration Examples

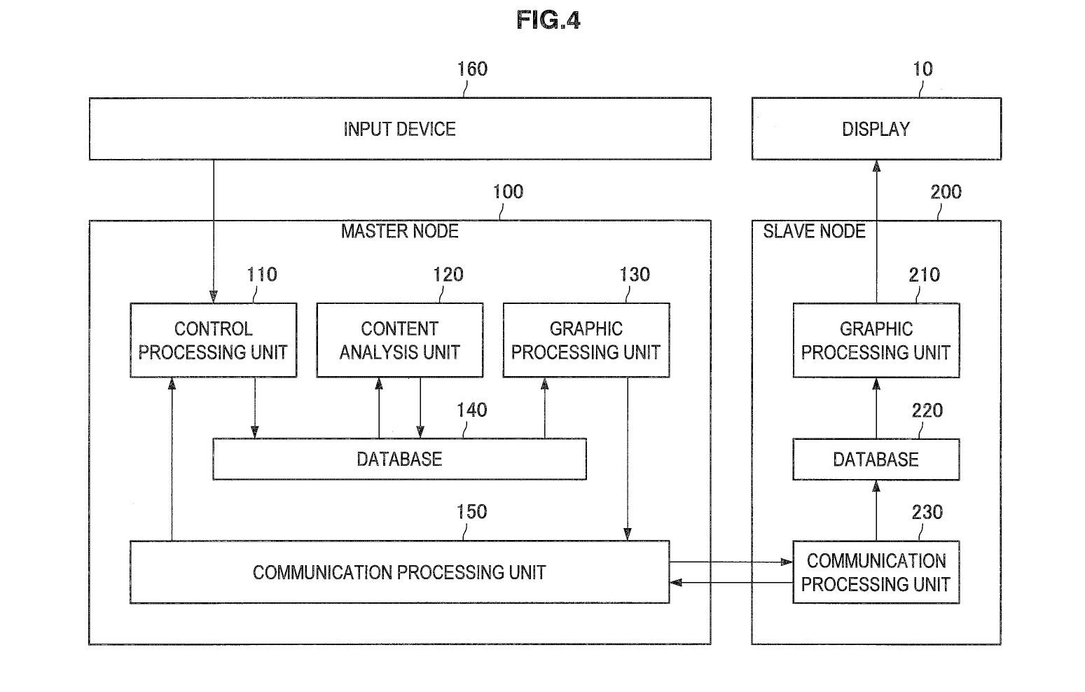

FIG. 4 is an explanatory diagram illustrating functional configuration examples of the master node 100 and each slave node 200 in the multi-display system 1 according to an embodiment of the present disclosure. Hereinafter, the functional configuration examples of the master node 100 and the slave node 200 will be described by using FIG. 4.

As illustrated in FIG. 4, the master node 100 includes a control processing unit 110, a content analysis unit 120, a graphic processing unit 130, a database 140, and a communication processing unit 150. The slave node 200 includes a graphic processing unit 210, a database 220, and a communication processing unit 230.

As illustrated in FIG. 4, the master node 100 is connected to an input device 160 including a keyboard, a mouse, a touch panel, a camera, and the like.

Firstly, description is provided of the functional configuration example of the master node 100. The control processing unit 110 executes processing for controlling operation of the master node 100. In the present embodiment, the control processing unit 110 executes processing for controlling the operation of the master node 100 based on information transmitted from the communication processing unit 150 and the input device 160.

The information transmitted from the communication processing unit 150 is, for example, information transmitted from the slave node 200, and information related to content to be displayed in the displays 10a to 10f. The information transmitted from the input device 160 is, for example, the content of operation performed on the input device 160. The control processing unit 110 records once in the database 140 the content of the processing based on the information transmitted from the communication processing unit 150 and the input device 160.

The content analysis unit 120 analyzes the content of the content to be displayed in the displays 10a to 10f. Specifically, the content analysis unit 120 determines: possible coordinates of objects (meaning any element included in the content, such as an object, an icon, a window, and other objects) of the content to be displayed in the displays 10a to 10f; vectors to be determined based on the determined coordinates; drawing resources and drawing commands for the objects for the determined coordinates.

When determining the possible coordinates of the objects of the content, the content analysis unit 120 uses: information on a range of displaying objects designated in advance for the content, a history of user operations of the input device 160 recorded in the database 140; and the like. The content analysis unit 120 records once in the database 140 the determined possible coordinates of the objects and the content of the drawing resources and drawing commands for the objects for the determined coordinates.

The graphic processing unit 130 is an example of an image processing unit according to an embodiment of the present disclosure and executes processing of transmitting the drawing resource and drawing command determined by the content analysis unit 120 to each slave node 200 responsible for displaying the displays 10 located on a possible vector of each object determined by the content analysis unit 120. The graphic processing unit 130 determines the displays 10 located on the possible vector of the object, for example, based on information on a coordinate range in which the displays in the multi-display system 1 are responsible for displaying the object.

The database 140 stores therein various data for displaying content in the multi-display system 1. Examples of data stored in the database 140 may include the coordinates range in which the displays in the multi-display system 1 are responsible for displaying objects, the content of the content to be displayed in the displays 10, possible coordinates of objects included in the content, vectors determined based on the possible coordinates of the objects, the drawing resources and drawing commands of objects for the determined coordinates, and a history of user operations of the input device 160.

The communication processing unit 150 executes processing of communication with each slave node 200. Specifically, the communication processing unit 150 transmits a drawing resource for an object which is transmitted by the graphic processing unit 130 to each slave node 200 responsible for displaying the corresponding display 10 located on a possible vector of the object. The communication processing unit 150 also transmits in order a drawing command for displaying the object to the slave node 200 responsible for displaying the object.

Subsequently, description is provided of the functional configuration example of each slave node 200. The graphic processing unit 210 is an example of the image processing unit according to an embodiment of the present disclosure and executes drawing processing of displaying the object in the display 10 based on the drawing resource and drawing command which are transmitted from the master node 100.

The database 220 stores therein various data for displaying the content in the multi-display system 1. Examples of data stored in the database 220 may include the content of content to be displayed in the display 10, possible coordinates of objects included in the content, vectors determined based on the possible coordinates of the objects, and the drawing resources and drawing commands for the objects for the determined coordinates.

The communication processing unit 230 executes processing of communication with the master node 100. Specifically, the communication processing unit 230 receives the drawing resource and drawing command transmitted from the master node 100. The communication processing unit 230 records once in the database 220 the received drawing resource and drawing command.

The master node 100 and the slave nodes 200 of the multi-display system 1 according to an embodiment of the present disclosure have such configurations and thus do not have to generate, transmit, and receive a drawing resource and a drawing command when an object is displayed astride a plurality of displays, thus being enabled to reduce the costs incurred.

The functional configuration examples of the master node 100 and the slave nodes 200 have heretofore been described by using FIG. 4. Subsequently, description is provided of a method for transmitting a drawing resource in the multi-display system 1 according to an embodiment of the present disclosure.

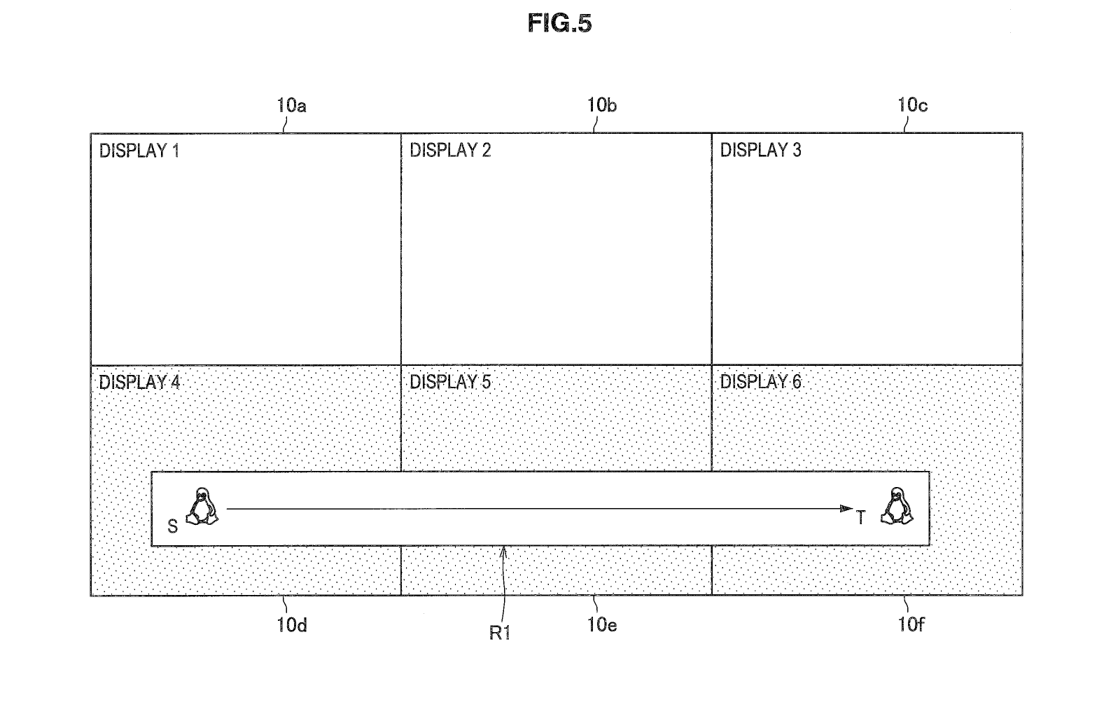

FIG. 5 is an explanatory diagram for explaining the method for transmitting a drawing resource. Hereinafter, the method for transmitting a drawing resource in the multi-display system 1 according to an embodiment of the present disclosure will be described by using FIG. 5.

FIG. 5 illustrates a case of multi-display image-display using the six displays 10a to 10f. For example, assume a case where the six displays 10a to 10f display content having an object A designated to move from a place S in the display 10d to a place T in the display 10f. In this case, a region in which the object A can move can be expressed by a region R1 in FIG. 5.

In the case where the object A moves from the place S in the display 10d to the place T in the display 10f, three displays that are the displays 10d, 10e, and 10f display the object A. Accordingly, the master node 100 determines the slave nodes 200d, 200e, and 200f respectively connected to the displays 10d, 10e, and 10f, as destinations for transmitting a drawing resource for the object A.

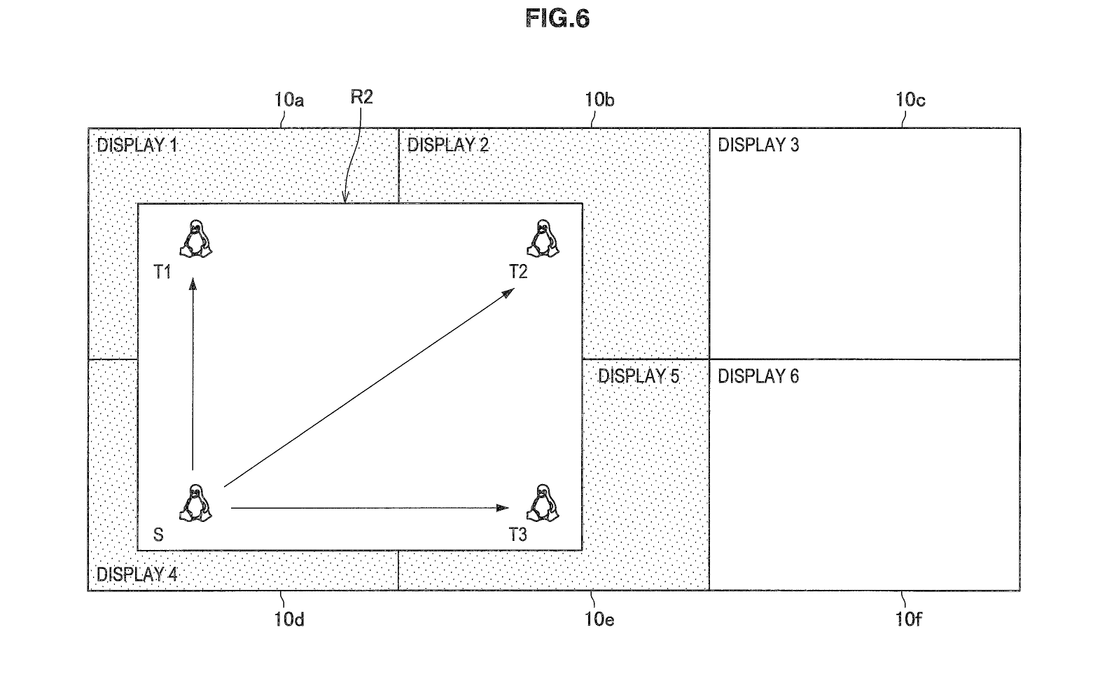

Another example will be described. FIG. 6 is an explanatory diagram for explaining the method for transmitting a drawing resource. Hereinafter, the method for transmitting a drawing resource in the multi-display system 1 according to an embodiment of the present disclosure will be described by using FIG. 6.

FIG. 6 illustrates a case of multi-display image-display using the six displays 10a to 10f, like FIG. 5. For example, assume a case where the six displays 10a to 10f display content having the object A designated to move from the place S in the display 10d to a place T1 in the display 10a, a place T2 in the display 10b, and a place T3 in the display 10e. In this case, a region in which the object A can move can be expressed by a region R2 in FIG. 6.

In the case where the object A moves from the place S in the display 10d to the place T1 in the display 10a, the place T2 in the display 10b, and the place T3 in the display 10e, the four displays that are the displays 10a, 10b, 10d, and 10e display the object A. Accordingly, the master node 100 determines the slave nodes 200a, 200b, 200d, and 200e respectively connected to the displays 10a, 10b, 10d, and 10e, as destinations for transmitting the drawing resource for the object A.

As described above, the master node 100 determines the slave nodes 200 as destinations for transmitting a drawing resource for an object included in content, based on a range in which the object can move. The master node 100 can transmit the drawing resource for the object to only the determined slave nodes 200. When receiving a drawing command for the drawing resource for the object from the master node 100, the slave nodes 200 receiving the drawing resource can display the object in the displays 10 based on the drawing command by using the drawing resource received in advance.

However, even though a moving range of an object is designated, user operation might result in a range different from the range designated in advance. In such a case, the master node 100 may modify the possible object-moving range and newly determine destinations for transmitting a drawing resource for the object based on the modified range.

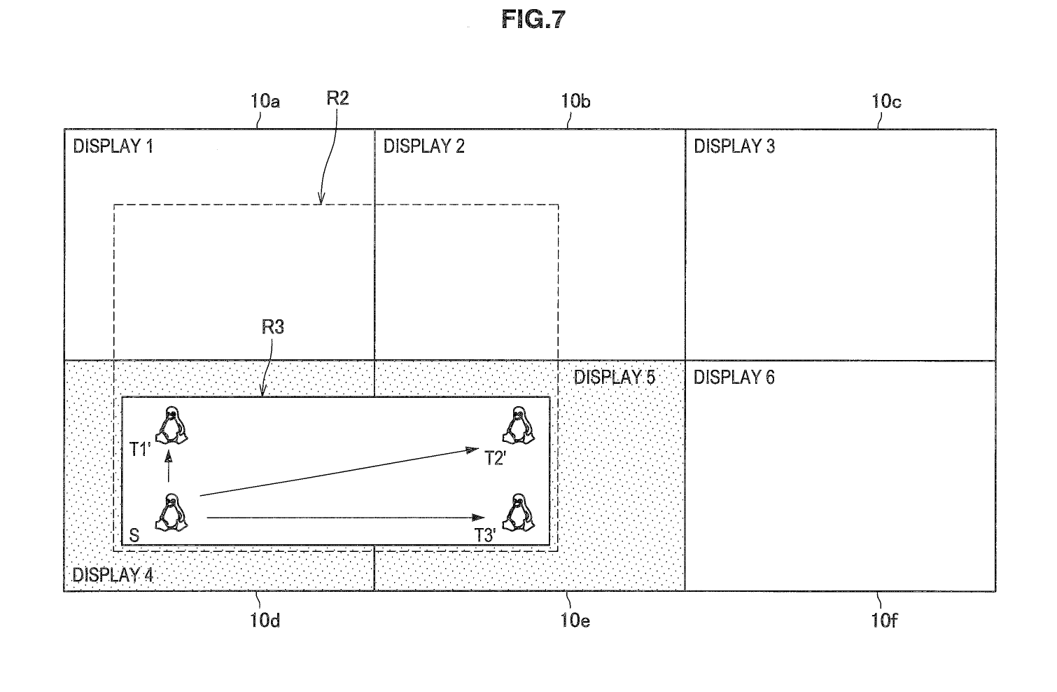

FIG. 7 is an explanatory diagram for explaining the method for transmitting a drawing resource. Hereinafter, the method for transmitting a drawing resource in the multi-display system 1 according to an embodiment of the present disclosure will be described by using FIG. 7.

FIG. 7 illustrates a case of multi-display image-display using the six displays 10a to 10f, like FIGS. 5 and 6. For example, assume a case where the six displays 10a to 10f display content having the object A whose moving destinations from the place S in the display 10d are changed to a place T1′ in the display 10d, a place T2′ in the display 10e, and a place T3′ in the display 10e, in accordance with the user operation. In this case, a region in which the object A can move can be expressed by a modified possible object-moving region R3 in FIG. 7.

In the case where the object A moves from the place S in the display 10d to the place T1′ in the display 10d, the place T2′ in the display 10e, and the place T3′ in the display 10e, the two displays that are the displays 10d and 10e display the object A. Accordingly, the master node 100 determines the slave nodes 200d and 200e respectively connected to the displays 10d and 10e as destinations for transmitting the drawing resource for the object A.

In the case where the user operation results in change of the possible object-moving region as described above, the master node 100 newly determines the slave nodes 200 as the drawing-resource transmission destinations and transmits the drawing resource to the determined modified slave nodes 200. In this way, the master node 100 changes the drawing-resource transmission destinations to transmit the drawing resource to the slave nodes 200. Even if the possible object-moving region is changed, the slave nodes 200 can thereby display the object in the displays 10 by using the drawing resource received in advance upon reception of a drawing command.

Note that FIGS. 5 to 7 each show the possible object-moving region using a rectangle, but the embodiment of the present disclosure is not limited to the examples.

The description has heretofore been provided of the method for transmitting a drawing resource in the multi-display system 1 according to an embodiment of the present disclosure. Subsequently, description is provided of operation examples of the multi-display system 1 according to an embodiment of the present disclosure.

### 1.3. Operation Examples

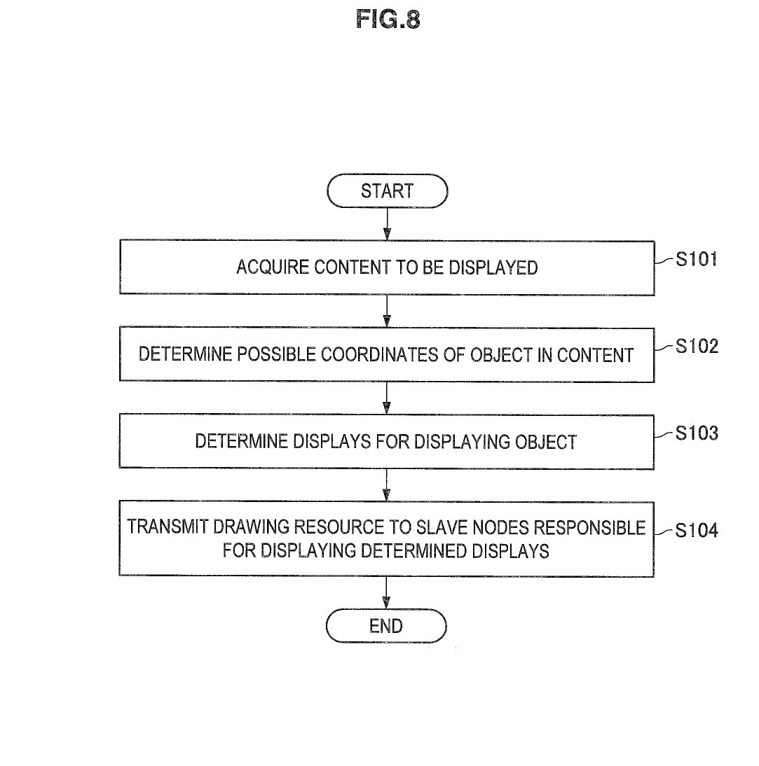

FIG. 8 is a flow chart illustrating an operation example of the multi-display system 1 according to an embodiment of the present disclosure. FIG. 8 shows an example of operation at the time when the master node 100 analyzes a display position of an object in content and transmits a drawing resource to the slave nodes 200 based on the analysis result. Hereinafter, the operation example of the multi-display system 1 according to an embodiment of the present disclosure will be described by using FIG. 8.

Firstly, the master node 100 acquires content to be displayed in the displays 10 (Step S101). The content to be displayed in the displays 10 may be in advance held in the master node 100 or may be acquired from the outside, such as a web site on the Internet. The acquisition of the content may be executed, for example, by the control processing unit 110.

After acquiring the content to be displayed in the displays 10 in Step S101 above, the master node 100 subsequently determines possible coordinates of an object in the content (Step S102). The determination processing may be executed, for example, by the content analysis unit 120. The determination processing in Step S102, for example, determination of possible coordinates of the object of the content uses information on an object display range designated in advance for the content, a history of user operations of the input device 160 recorded in the database 140, and the like.

After determining the possible coordinates of the object in the content in Step S102 above, the master node 100 subsequently determines the displays 10 for displaying the object based on the determined coordinates (Step S103). The determination processing may be executed, for example, by the graphic processing unit 130.

After determining the displays 10 for displaying the object in Step S103 above, the master node 100 transmits a drawing resource for the object to the slave nodes 200 responsible for displaying the determined displays 10 (Step S104). The transmission processing may be executed, for example, by the graphic processing unit 130.

When an object is displayed in such a manner as to move astride a plurality of displays, the master node 100 of the multi-display system 1 according to an embodiment of the present disclosure executes such operation, and thereby does not have to generate, transmit, and receive the drawing resource for, to, and from the slave nodes responsible for display not intended for the object, thus being enabled to reduce the costs incurred.

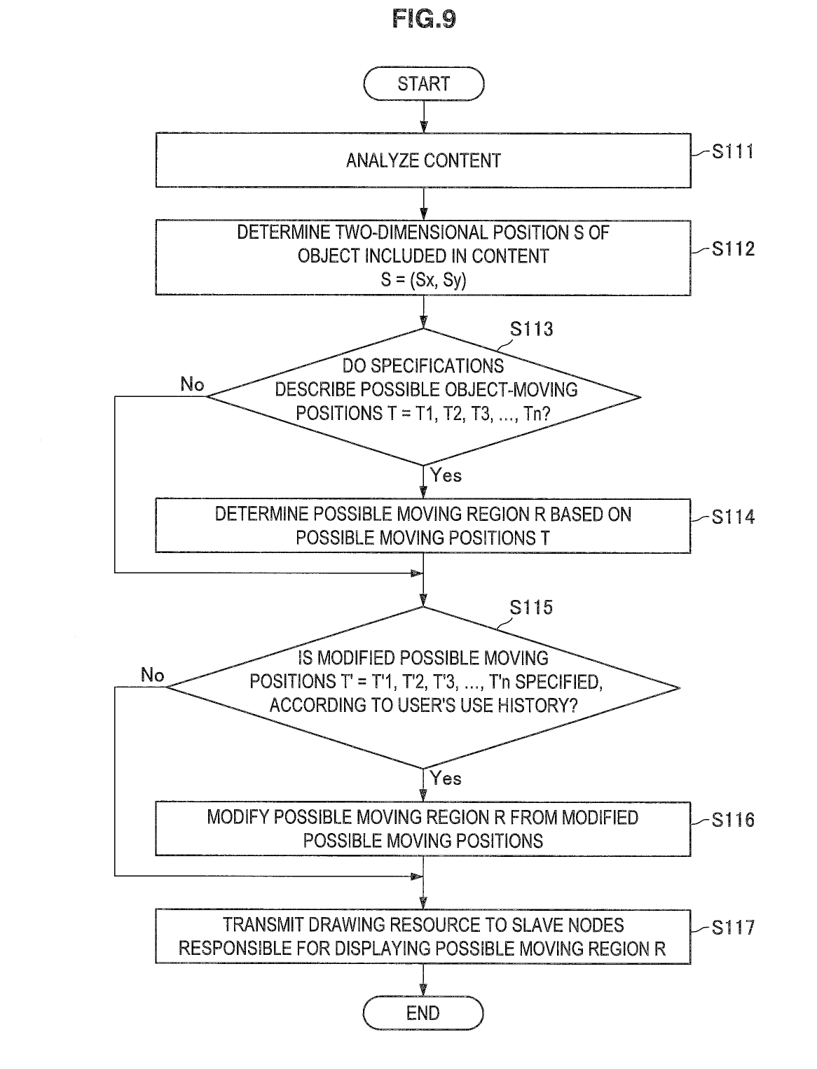

Subsequently, content analysis processing by the master node 100 will be described in detail. The description is herein provided of an operation example taken in consideration for a case where user operation or the like results in change of a possible object-moving region. FIG. 9 is a flowchart illustrating an operation example of the multi-display system 1 according to an embodiment of the present disclosure. FIG. 9 shows an example of operation at the time when the master node 100 analyzes a display position of an object in content and transmits a drawing resource to the slave nodes 200 based on the analysis result. Hereinafter, the operation example of the multi-display system 1 according to an embodiment of the present disclosure will be described by using FIG. 9.

The master node 100 analyzes the content of the content to be displayed in the displays 10 (Step S111). The analysis processing may be executed, for example, by the content analysis unit 120. The analysis processing in Step S111, for example, determination of possible coordinates of the object of the content uses information on an object display range designated in advance for the content, a history of user operations of the input device 160 recorded in the database 140, and the like.

After executing the analysis processing in Step S111 above, the master node 100 subsequently determines a two-dimensional position S=(Sx, Sy) of the object included in the content (Step S112). The determination processing may be executed, for example, by the content analysis unit 120.

After executing the determination processing in Step S112 above, the master node 100 subsequently judges whether the specifications of the content describe positions T=T1, T2, T3, . . . , Tn that are possible object-moving positions (Step S113). The judging processing may be executed, for example, by the content analysis unit 120.

If it is judged in Step S113 that the specifications of the content describe the possible object-moving positions, the master node 100 subsequently determines a possible object-moving region R based on the possible moving positions T (Step S114). The determination processing may be executed, for example, by the content analysis unit 120. On the other hand, if it is judged in Step S113 that the specifications of the content do not describe the possible object-moving positions, the master node 100 skips the processing in Step S114.

The master node 100 subsequently refers to a user's use history to judge whether modified possible moving positions T′=T1′, T2′, T3′, . . . , Tn′ are specified for the object (Step S115). The judging processing may be executed, for example, by the content analysis unit 120.

If it is judged in Step S115 that the modified possible moving positions are specified for the object, the master node 100 subsequently modifies the possible object-moving region R based on the positions T′ (Step S116). The modification processing may be executed, for example, by the content analysis unit 120. On the other hand, if it is judged in Step S115 that the specifications of the content do not describe the possible object-moving positions, the master node 100 skips the processing in Step S116.

The master node 100 subsequently transmits the drawing resource for the object to the slave nodes 200 responsible for displaying the possible object-moving region R (Step S117). The transmission processing may be executed, for example, by the graphic processing unit 130. Note that the master node 100 may instruct one or more slave nodes 200 responsible for displaying the displays 10 not any more included in the modified region R to discard the drawing resource.

When the object is displayed in such a manner as to move astride the plurality of displays, the master node 100 of the multi-display system 1 according to an embodiment of the present disclosure executes such operation, and thereby does not have to generate, transmit, and receive the drawing resource for, to, and from the slave nodes responsible for display not intended for the object, thus being enabled to reduce the costs incurred.

In addition, when user operation results in change of the possible object-moving region, the master node 100 of the multi-display system 1 according to an embodiment of the present disclosure executes such operation, and thereby can generate a drawing resource based on the change to transmit the drawing resource, thus being enabled to reduce the costs incurred in generating, transmitting, receiving the drawing resource for the region not any more displayed.

For example, assume a case of displaying such an object not predictable when to display as an object to be displayed in accordance with user operation, such as a menu. In this case, the master node 100 in advance transmits a drawing resource for the object to be displayed in accordance with the user operation, to any one of the slave nodes 200 which is responsible for displaying the corresponding display 10 for displaying the menu. Upon detection of the user operation, the master node 100 transmits a drawing command to the slave node 200 responsible for display of the menu.

Also assume a case where the master node 100 thereafter knows that a certain display 10 does not display the menu, according to the user operation history. In this case, the master node 100 may instruct the slave node 200 responsible for the display 10 not intended to display the menu to discard the drawing resource. By discarding the drawing resource for the menu, the slave node 200 responsible for the display 10 not intended to display the menu can reduce costs involved with reception and holding of the drawing resource.

### 1.4. Modifications

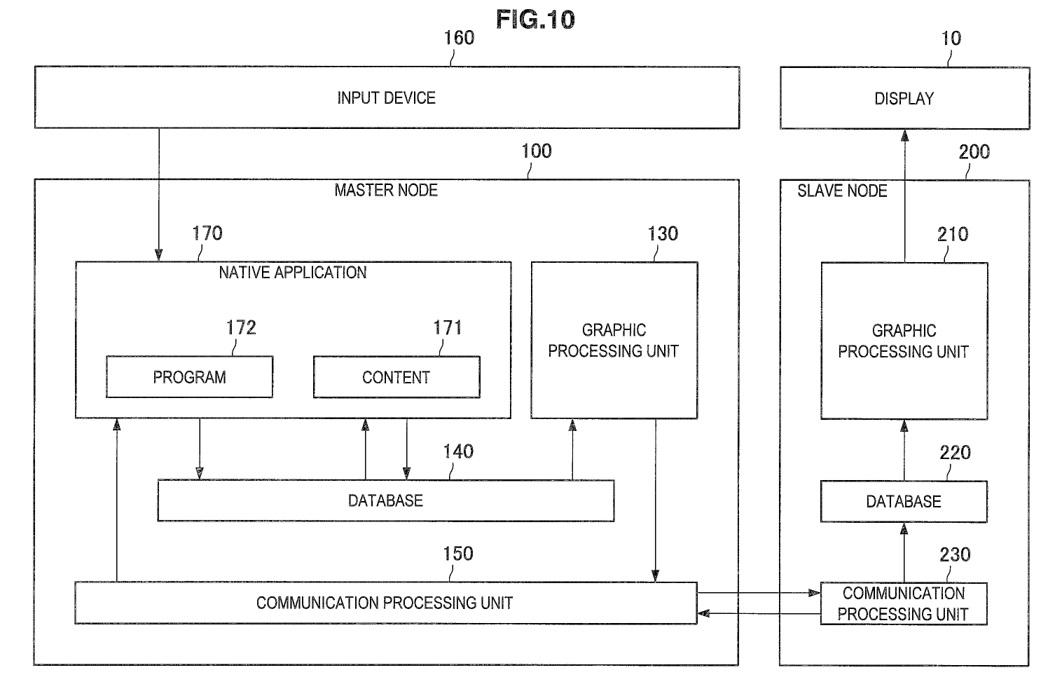

Subsequently, description is provided of modifications of an embodiment of the present disclosure. FIG. 10 is an explanatory diagram illustrating a functional configuration example of the master node 100 of the multi-display system 1 according to a first modification of an embodiment of the present disclosure. FIG. 10 shows how the master node 100 functions to execute a native application 170.

The native application 170 includes: content 171 having characters, figures, photos, videos, and the like; and a program 172 for determining coordinates of objects included in the content 171. By executing the native application 170, the master node 100 determines coordinates of the objects included in the content 171 according to the program 172.

The content 171 included in the native application 170 may have been included in the native application 170 when the master node 100 is manufactured or may be added later through download from the Internet, software update, or the like.

The content 171 included in the native application 170 is configured such that the size and the position of each object can be dynamically changed through user operation of the input device 160. The program 172 detects change of the size or position of the object in response to the operation of the input device 160, and again determines coordinates of the objects included in the content 171.

After the program 172 determines the coordinates of the objects included in the content 171, the graphic processing unit 130 determines drawing resources and drawing commands of the content 171. The graphic processing unit 130 then transmits the determined drawing resources and drawing commands to the slave nodes 200 responsible for displaying the content 171 through the communication processing unit 150.

When an animation of the content 171 is specified, the graphic processing unit 130 may reflect the specifications of the animation on a possible object-moving region.

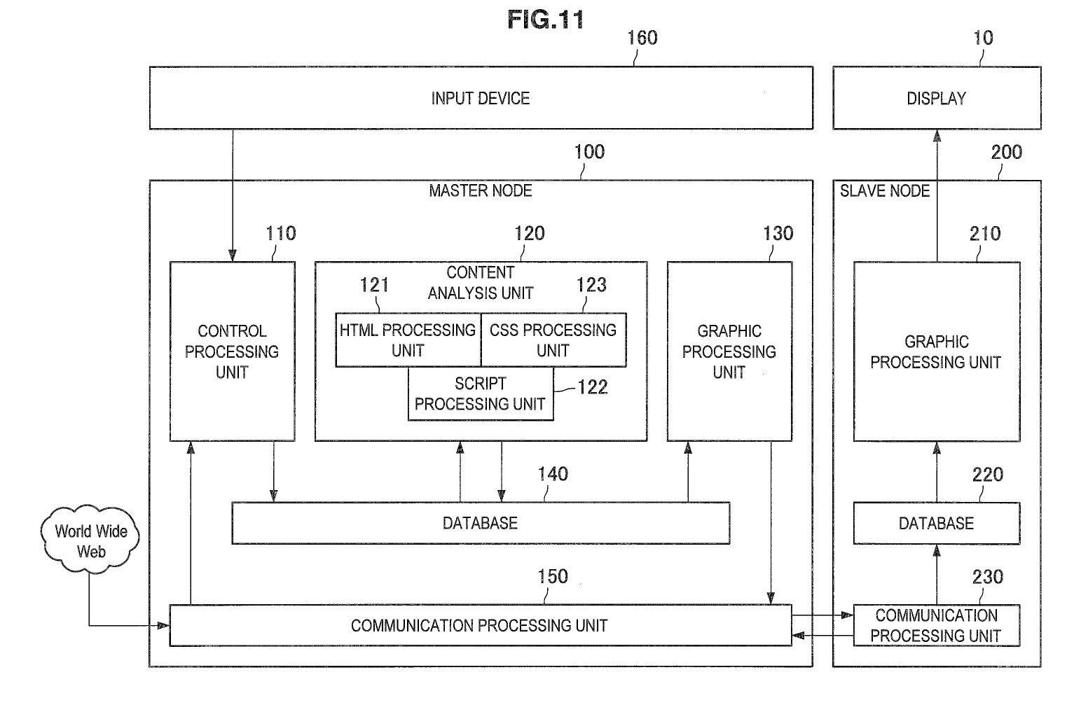

FIG. 11 is an explanatory diagram illustrating a functional configuration example of the master node 100 of the multi-display system 1 according to a second modification of an embodiment of the present disclosure. FIG. 11 shows that a content analysis unit 120 of the master node 100 includes an HTML processing unit 121, a script processing unit 122, and a CSS processing unit 123.

The communication processing unit 150 of the master node 100 in FIG. 11 has a function of connecting to the World Wide Web (WWW). The master node 100 has a function of displaying, in the displays 10, content (for example, a web page) acquired by connecting to the WWW.

The web page acquired by the master node 100 through connection to the WWW can include various objects such as characters, figures, photos, videos, and application programs. The master node 100 causes the HTML processing unit 121 to analyze an HTML of the objects included in the web page for rendering the objects and analyzes a DOM tree. The master node 100 also causes the script processing unit 122 to execute processing for scripts (for example, JavaScript) included in the web page. The master node 100 further causes the CSS processing unit 123 to execute a CSS analysis for displaying the web page to build a render tree (or a frame tree) and thereby determines coordinates of the objects in the web page.

The master node 100 can determine the coordinates of the objects included in the web page acquired by connecting to the WWW, based on the processing by the HTML processing unit 121, the script processing unit 122, and the CSS processing unit 123. The master node 100 then causes the graphic processing unit 130 to determine drawing resources and drawing commands for the web page. The master node 100 then causes the graphic processing unit 130 to transmit the determined drawing resources and drawing commands through the communication processing unit 150 to the slave nodes 200 responsible for displaying the web page.

Each object in the web page is configured such that the size and the position of the object can be dynamically changed through user operation of the input device 160. The CSS processing unit 123 rebuilds the render tree of the web page according to the change. The graphic processing unit 130 determines the drawing resources and drawing commands of the web page based on the rebuilt render tree.

When CSS or the like specify an animation of the objects in the web page, the graphic processing unit 130 may reflect the specifications of the object animation acquired by the CSS processing by the CSS processing unit 123 on a possible object-moving region.

FIG. 11 shows that the master node 100 connects to the WWW to acquire the content, but the embodiment of the present disclosure is not limited to the example. The master node 100 may be configured to acquire the content through not only the WWW but also, for example, Ethernet (registered trademark), Wi-Fi, a universal serial bus (USB), or Bluetooth (registered trademark).

### 2. HARDWARE CONFIGURATION EXAMPLE

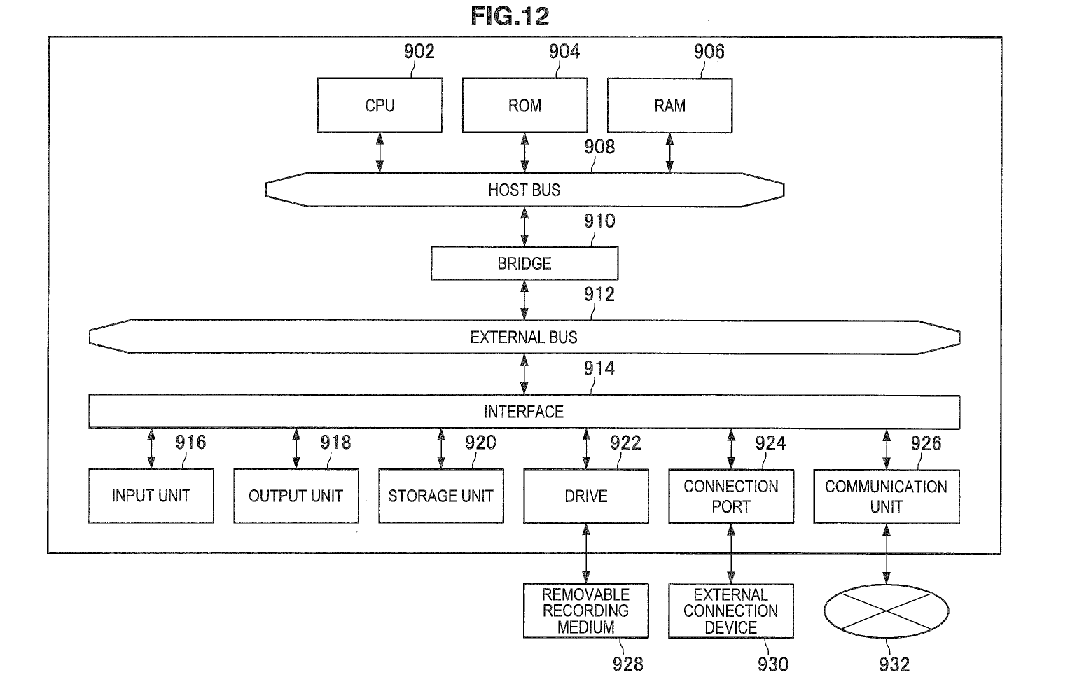

The algorithm described above can be executed by using, for example, a hardware configuration in FIG. 12. In other words, the processing based on the algorithm can be implemented by using a computer program and by controlling hardware in FIG. 12. Note that any form of the hardware may be used, including, for example: a mobile information terminal such as a personal computer, a mobile phone, a personal handy-phone system (PHS), or a personal digital assistant (PDA); a game machine; a contact or non-contact integrated circuit (IC) chip; a contact or non-contact IC card; and various personal digital electronics.

As illustrated in FIG. 12, the hardware mainly includes a central processing unit (CPU) 902, a read only memory (ROM) 904, a random access memory (RAM) 906, a host bus 908, and a bridge 910. The hardware further includes an external bus 912, an interface 914, an input unit 916, an output unit 918, a storage unit 920, a drive 922, a connection port 924, and a communication unit 926.

The CPU 902 functions, for example, as an arithmetic processing unit or a control device, and controls overall operation or part of each component based on various programs recorded in the ROM 904, the RAM 906, the storage unit 920, or a removable recording medium 928. The ROM 904 is means for storing programs read by the CPU 902, data used for arithmetic operation, and the like. The RAM 906 temporarily or permanently stores therein, for example, the programs read by the CPU 902 and various parameters appropriately varying in executing the programs.

The components are connected to each other, for example, through the host bus 908 capable of high-speed data transmission. In contrast, the host bus 908 is connected to the external bus 912 having relatively low data transmission speed, for example, through the bridge 910. For example, a mouse, a keyboard, a touch panel, buttons, a switch, a lever, and the like are used as the input unit 916. Further, a remote control (remote) might also be used as the input unit 916, the remote being capable of control signals using infrared rays and other electronic waves.

The output unit 918 is a device capable of visibly or audibly notifying the user of acquired information, such as: a display device such as a cathode ray tube (CRT), a liquid crystal display (LCD), a plasma display panel (PDP), or an electro-luminescence display (ELD); an audio output device such as a speaker or a headphone; a printer; a mobile phone; or a fax machine.

The storage unit 920 is a device for storing various data. For example, a magnetic storage device such as a hard disk drive (HDD), a semiconductor storage device, an optical storage device, or a magneto-optical storage device is used as the storage unit 920.

The drive 922 is a device that reads information recorded in the removable recording medium 928 such as a magnetic disk, an optical disk, a magneto-optical disk, or a semiconductor memory, and that writes information in the removable recording medium 928. The removable recording medium 928 is, for example, a DVD medium, a Blu-ray medium, a HD DVD medium, or any of various semiconductor storage media. It goes without saying that the removable recording medium 928 may be, for example, an IC card having a non-contact IC chip mounted thereon, or an electronic device.

The connection port 924 is a port for connecting to an external connection device 930, such as a USB port, an IEEE 1394 port, a small computer system interface (SCSI), an RS-232C port, or an optical audio terminal. The external connection device 930 is, for example, a printer, a mobile music player, a digital camera, a digital video camera, or an IC recorder.

The communication unit 926 is a communication device for connecting to a network 932, and is, for example, a communication card for a wired or wireless local area network (LAN), Bluetooth (registered trademark), or wireless USB (WUSB), a router for optical communication, a router for asymmetric digital subscriber line (ADSL), or a device for contact or non-contact communication. The network 932 connected to the communication unit 926 is configured of a network connected in a wired or wireless manner, and is, for example, the Internet, a home LAN, infrared-ray communication, visible light communication, broadcast, or satellite communication.

### 3. CONCLUSION

According to an embodiment of the present disclosure as described above, when an object may be displayed in a plurality of displays in a multi-display system using tiled arrangement of the plurality of displays to implement displaying on a large screen, it is possible to provide a multi-display system in which a master node in advance determines a possible object-moving region and transmits drawing resources to only slave nodes responsible for displaying in the region.

In the multi-display system according to an embodiment of the present disclosure, the master node in advance determines the possible object-moving region and transmits drawing resources to only the slave nodes responsible for displaying the region. When an object moves astride the displays, it is not necessary to transmit and receive the drawing resources between the master node and the slave nodes responsible for the displaying in moving destinations every time the object moves astride the displays, and thus is possible to reduce the costs incurred.

For example, when an icon, a cursor, a window, or other objects move astride the displays, the master node does not have to transmit the drawing resources again to the slave nodes. The multi-display system according to an embodiment of the present disclosure can contribute to reduction of loads on the master node in generating and transmitting the drawing resources.

In addition, the multi-display system according to an embodiment of the present disclosure in advance transmits the drawing resources to the slave nodes, and thus the multi-display system according to an embodiment of the present disclosure can contribute to improvement in operability and responses in comparison with the case where the master node again transmits the drawing resources to the slave nodes. Moreover, any slave node responsible for display not intended for the object does not receive an unnecessary drawing resource, and thereby the multi-display system according to an embodiment of the present disclosure can contribute to reduction of processing loads on the slave nodes.

Steps of each process executed by each apparatus in the specification do not necessarily have to be performed in time-series in the order of the steps described in a sequence diagram or the flowchart. For example, the steps of the process executed by the apparatus may be performed in the order different from that described in the flowchart or may be performed in parallel.

It is also possible to generate a computer program for causing the hardware such as the CPU, the ROM, and the RAM which are built in each apparatus to exert functions equivalent to those in the aforementioned configuration of the apparatus. It is also possible to provide a storage medium storing the computer program. It is also possible to implement the series of processes by hardware, by configuring each functional block illustrated in the functional block diagram by hardware.

It should be understood by those skilled in the art that various modifications, combinations, sub-combinations and alterations may occur depending on design requirements and other factors insofar as they are within the scope of the appended claims or the equivalents thereof.

In addition, the advantageous effects described in the specification are merely explanatory or illustrative, and are not limited. In other words, the technology according to the present disclosure can exert other advantageous effects that are clear to those skilled in the art from the description of the specification, in addition to or instead of the advantageous effects described above.

Additionally, the present technology may also be configured as below:

(1) An image processing apparatus including:

a content analysis unit configured to analyze a display range of an object included in content displayed in a plurality of displays; and

an image processing unit configured to generate drawing information for drawing the object and to transmit the drawing information to only an apparatus responsible for display processing in at least one of the displays that includes the display range acquired through the analysis by the content analysis unit.

(2) The image processing apparatus according to (1),

wherein the content analysis unit detects change of the display range, and

wherein in response to the detection of the change of the display range by the content analysis unit, the image processing unit changes the apparatus to which the drawing information is transmitted.

(3) The image processing apparatus according to (2),

wherein the content analysis unit modifies the display range according to a user operation history.

(4) The image processing apparatus according to (3),

wherein in accordance with the modification of the display range by the content analysis unit, the image processing unit changes the apparatus to which the drawing information is transmitted.

(5) An image processing apparatus including:

a communication processing unit configured to receive drawing information for drawing an object included in content displayed in a plurality of displays, the drawing information being transmitted to only an apparatus responsible for display processing in at least one of the displays that includes a display range of the object; and

an image processing unit configured to display the object in the display responsible for displaying the object, based on the drawing information received by the communication processing unit.

(6) An image processing method including:

analyzing a display range of an object included in content displayed in a plurality of displays; and

generating drawing information for drawing the object and transmitting the drawing information to only an apparatus responsible for display processing in at least one of the displays that includes the display range acquired by analyzing the display range of the object.

(7) An image processing method including:

receiving drawing information for drawing an object included in content displayed in a plurality of displays, the drawing information being transmitted to only an apparatus responsible for display processing in at least one of the displays that includes a display range of the object; and

displaying the object in the display responsible for displaying the object, based on the received drawing information.

(8) An image processing system including:

a first image processing apparatus configured to generate drawing information for displaying content in a plurality of displays; and

one or more second image processing apparatuses configured to receive the drawing information from the first image processing apparatus and to display the content in the displays responsible for displaying the content,

wherein the first image processing apparatus includes
a content analysis unit that analyzes a display range of an object included in the content displayed in the plurality of displays, and
an image processing unit that generates the drawing information for drawing the object and to transmit the drawing information to only at least one of the second image processing apparatuses that is responsible for display processing in the corresponding display including the display range acquired through the analysis by the content analysis unit, and

wherein each second image processing apparatus includes
a communication processing unit that receives the drawing information for drawing the object included in the content displayed in the plurality of displays, the drawing information being transmitted to only the second image processing apparatus responsible for the display processing in the display including the display range of the object, and
an image processing unit that displays the object in the display responsible for displaying the object, based on the drawing information received by the communication processing unit.

What is claimed is:

1. An image processing apparatus comprising:
a content analysis unit configured to analyze a display range of an object included in content displayed in a plurality of displays; and
an image processing unit configured to generate drawing information for drawing the object and to transmit the drawing information to only an apparatus responsible for display processing in at least one of the displays that includes the display range acquired through the analysis by the content analysis unit.

2. The image processing apparatus according to claim 1,
wherein the content analysis unit detects change of the display range, and
wherein in response to the detection of the change of the display range by the content analysis unit, the image processing unit changes the apparatus to which the drawing information is transmitted.

3. The image processing apparatus according to claim 1,
wherein the content analysis unit modifies the display range according to a user operation history.

4. The image processing apparatus according to claim 3,
wherein in accordance with the modification of the display range by the content analysis unit, the image processing unit changes the apparatus to which the drawing information is transmitted.

5. An image processing apparatus comprising:
a communication processing unit configured to receive drawing information for drawing an object included in content displayed in a plurality of displays, the drawing information being transmitted to only an apparatus responsible for display processing in at least one of the displays that includes a display range of the object; and
an image processing unit configured to display the object in the display responsible for displaying the object, based on the drawing information received by the communication processing unit.

6. An image processing method comprising:
analyzing a display range of an object included in content displayed in a plurality of displays; and
generating drawing information for drawing the object and transmitting the drawing information to only an apparatus responsible for display processing in at least one of the displays that includes the display range acquired by analyzing the display range of the object.

7. An image processing method comprising:
receiving drawing information for drawing an object included in content displayed in a plurality of displays, the drawing information being transmitted to only an apparatus responsible for display processing in at least one of the displays that includes a display range of the object; and
displaying the object in the display responsible for displaying the object, based on the received drawing information.
